(19) United States
(12) Patent Application Publication
(10) Pub. No.: US 2026/0159054 A1
(43) Pub. Date: Jun. 11, 2026

(54) MODULAR SYSTEM FOR A BRAKE FORCE DEVICE AND METHOD FOR PRODUCING A BRAKE FORCE DEVICE FROM A MODULAR SYSTEM

(71) Applicant: Robert Bosch GmbH, Stuttgart (DE)

(72) Inventors: Christian Jammes, Ludwigsburg (DE); Mark Boehm, Lehrensteinsfeld (DE); Matthias Lauermann, Heilbronn (DE); Sebastian Bauer, Bad Wimpfen (DE); Willi Nagel, Remseck/Hochdorf (DE)

(21) Appl. No.: 19/129,228

(22) PCT Filed: Jan. 26, 2024
(86) PCT No.: PCT/EP2024/051894

§ 371 Date: May 12, 2025

(30) Foreign Application Priority Data
Feb. 17, 2023 (DE) 10 2023 201 377.0

(51) Int. Cl. B60T 11/20

(52) U.S. Cl. CPC B60T 11/20

(57) ABSTRACT

A modular system for a brake force device. The modular system includes a system housing with a predetermined system length and an elongate inner recess, wherein the system housing is usable for an auxiliary brake and/or for a power brake and/or for a pressure generator; a brake cylinder device, which is insertable into the recess of the system housing and has at least one brake cylinder and a predetermined cylinder length; and a return spring, which has a predetermined spring length and a predetermined cross-sectional shape and is insertable into the recess of the system housing.

### FIELD

The present invention relates to a modular system for a brake force device and to a method for producing a brake force device from a modular system.

### BACKGROUND INFORMATION

A brake force device may inter alia be formed as an electromechanical brake booster or as a pressure brake unit (part of a brake-by-wire brake system). These two concepts usually have different dimensions of their system housing and other components and therefore require separate manufacture. In both concepts, the brake components (the brake mechanics for actuating the brake cylinders) can be driven via an electric motor, which may be connected to a transmission.

The transmission may be comprised of a worm and threaded-screw transmission, wherein, in the case of an electromechanical brake booster, a combination of motor actuation and driver actuation can be carried out in a so-called driver demand unit (DDU) in a center region of the housing. Furthermore, a differential path between the electric motor position and the driver rod can be ascertained, which may represent a control variable for operating the electromechanical brake booster.

PCT Patent Application No. WO 2013/083243 A1 describes a power train of an all-wheel-drive vehicle.

### SUMMARY

The present invention provides a modular system for a brake force device and a method for producing a brake force device from a modular system.

Preferred developments of the present invention are disclosed herein.

The present invention provides a modular system for a brake force device and a method for producing a brake force device from a modular system, wherein as many common parts as possible can be used for different embodiments.

According to an example embodiment of the present invention, the modular system for a brake force device comprises a system housing with a predetermined system length and an elongate inner recess, wherein the system housing is usable for an auxiliary brake and/or for a power brake and/or for a pressure generator; a brake cylinder device, which is insertable into the recess of the system housing and has at least one brake cylinder and a predetermined cylinder length; a return spring, for example for a transmission, which return spring has a predetermined spring length and a predetermined cross-sectional shape and is insertable into the recess of the system housing.

The modular system can correspond to a specification of components and associated tools, with which a basic structure can then be provided, which can then be expanded to a specific device with further processing or equipment. The system housing may be in one piece or composed of multiple parts. An elongate recess may extend along a main extension direction of the system housing. The brake cylinder device may comprise a tandem master brake cylinder, for example. The predetermined cylinder length may be selectable, for example, such that multiple different types of brake force devices may be producible. The predetermined spring length and its predetermined cross-sectional shape may be provided depending on the spring characteristic, for example a spring force required for a particular restoring force.

An auxiliary brake may be designed as a so-called servo brake or a brake booster, which may comprise a so-called driver demand unit DDU in an inner region; in other words, a driver request detection device as a unit for detecting the driver request, (for example, a reaction disk or rubber disk for combining driver force and actuator force). By means of the DDU, the driver request can be detected. The pedal force of the driver is boosted.

In a power brake, the brake force is applied completely by the actuator. This type of brake may have a simulator, i.e., the pedal force may be eliminated in the simulator (except in the fallback level when the brake device is not operating properly). The simulator may generate the pedal feel for the driver.

The pressure generator does not have a DDU or a simulator. The actuator directly actuates the master brake cylinder (TMC) and may also be a type of power brake unit.

In the pressure generator, the actuation (of the brake force) may be carried out by the electric motor alone and (the housing or a brake component) may comprise a rotor position sensor of the electronically commutated electric motor. A threaded spindle may be present and advantageously directly actuates the TMC (tandem master brake cylinder).

Furthermore, according to an example embodiment of the present invention, a driver demand unit (DDU) may be present only in an auxiliary brake and have a corresponding (specified) installation length for the recess (for example, the center region) and is not required for the pressure generator, wherein its installation space (for example, the center region) can therefore be used or filled by the TMC and advantageously contributes to keeping the overall length of the structural components for the recess as short as possible. The pressure generator and the auxiliary brake and the power brake can therefore be approximately the same length with respect to their existing or required components for the recess and can therefore be inserted into the same system housing of the modular system.

In the event that the first piston (primary piston) in the tandem master brake cylinder is in the zero position, the TMC can draw brake fluid from the reservoir via a ring groove with suction line in the customary structure. In the case of the electrical brake force device, the suction line may usually be designed as an angled bore and, in the case of the pressure unit, it may be a horizontal bore, which can be tightly sealed with a ball. According to the modular system, the brake cylinder device can advantageously have a primary port and a sniff hole, and a through-hole extends in horizontal alignment between the sniff hole and the primary port and at least in regions along the elongate recess. This structure can be used as a basic structure for the power brake as well as for the auxiliary brake and the pressure generator.

According to a preferred embodiment of the modular system of the present invention, the recess of the system housing comprises a front region and a center region, wherein the brake cylinder device is insertable into the front region.

The front region may have a smaller diameter than the center region and may have a circular or different cross-section. The insertable components, such as the (tandem) master brake cylinder, the return spring, spindle elements, plungers, transmission elements, or others, may then be positioned at a designated position in the center region, the front region, or a rear region depending on the application and may also extend beyond one region into another region if necessary. The rear region may face an input rod to the driver pedal and may adjoin the center region.

According to an example embodiment of the present invention, the modular system may comprise the return spring.

According to a preferred embodiment of the modular system of the present invention, the brake cylinder device comprises a primary port, a sniff hole, and a through-hole extending in horizontal alignment between the primary port and the sniff hole and at least in regions along the elongate recess.

According to a preferred embodiment of the modular system of the present invention, a first distance between the primary port and the system housing has a predetermined value.

The distance may be chosen such that the position of the primary port and of the sniff hole may be suitable for forming different brake force devices. For example, depending on the space required for the master brake cylinders and further components in the recesses, a return spring and also these components themselves may be positioned accordingly for different brake force devices.

According to a preferred embodiment of the modular system of the present invention, the return spring has a circular or elliptical wire cross-section, perpendicular to a central axis of the return spring, with a predetermined radius or a predetermined semimajor or semiminor axis, and wherein the return spring has a predetermined length along the central axis.

By varying the wire cross-section and/or radius of the return spring, its spring constant may be influenceable. For an identical spring output, the length of the return spring can thus be varied according to the required space in the system housing since varying the wire cross-section and/or the radius keeping the spring output (force distributed to length and cross-section or other spring characteristic) the same (or nearly the same) is accompanied by a change in the space required for the spring in the system housing. With less space available, a shorter spring may thus suffice as a result of varying the wire cross-section and/or radius.

According to a preferred embodiment of the modular system of the present invention, the return spring has a non-circular wire cross-section.

By varying the wire cross-section, the spring output (spring constant) may be varied as needed, and a wire cross-section or radius of the spring (in cross-section) or its length may be varied according to the required space or output of the spring.

According to a preferred embodiment of the modular system of the present invention, the brake cylinder device for an auxiliary brake and/or for a power brake and/or for a pressure generator has the same physical dimensions and inner structure.

With such a basic configuration of the system housing, the system housing can consist of common parts and can consequently be used and/or processed for various concepts of the brake cylinder device.

According to a preferred embodiment of the modular system of the present invention, the brake cylinder device can partially be pushed into the center region.

According to a preferred embodiment of the modular system of the present invention, a spindle is insertable into the center region and extends to a predetermined inner distance toward the brake cylinder device.

According to a preferred embodiment of the modular system of the present invention, the auxiliary brake and/or the power brake and/or the pressure generator are provided from a modular kit with an identical transmission, in particular a worm transmission, at an identical position and comprises a structurally identical brake cylinder device and/or a structurally identical system housing and/or a structurally identical spindle with a spindle nut.

According to a preferred embodiment of the modular system of the present invention, the auxiliary brake comprises a driver demand unit, which is arranged between the brake cylinder device and a spindle nut, wherein the spindle is hollow-bored and a plunger, which is mounted therein and connected to the driver, actuates the driver demand unit.

According to a preferred embodiment of the modular system of the present invention, in the case of the auxiliary brake and/or the pressure generator, an anti-rotation torque of the spindle transmission is supported on at least two grooves of the system housing via at least two finger elements of the anti-rotation plate, which is connected to the spindle, wherein the grooves are preferably rectangular grooves.

According to a preferred embodiment of the modular system of the present invention, in the case of the pressure generator in contrast to the auxiliary brake, the spindle nut takes the place of the driver demand unit, whereby the anti-rotation torque is transmitted around the spindle nut by means of a canister or two offset levers before being supported via two finger elements.

According to a preferred embodiment of the modular system of the present invention, on a lateral side of the system housing, the modular system comprises an adapter plate for fastening the brake force device to a vehicle bulkhead in the engine compartment.

According to a preferred embodiment of the modular system of the present invention, the pressure generator comprises a cover for sealing the system housing.

A modular system that is commonly usable for multiple brake force device concepts can advantageously be provided using as many common parts as possible.

The system housing and the structural parts for the brake force device can be assembled on an assembly line for all applicable concepts. A maximum overall length of the system housing and/or of the recess may be specified.

According to the modular system according to an example embodiment of the present invention, a first distance may have a specified minimum length. After application of the system housing, a uniform TMC (or other brake cylinder) can be used for different types of brake force devices. In comparison to conventional structures of brake force devices, an outer diameter (in cross-section) of a return spring can be selected to be smaller. A smaller diameter may result in lengthening of the spring and in exceeding the predetermined length, although this may be influenced through the choice of a wire cross-section.

According to an example embodiment of the present invention, in a method for producing a brake force device from a modular system, a system housing with a predetermined system length and an elongate inner recess is provided, wherein the system housing is usable for an auxiliary brake and/or for a power brake and/or for a pressure generator; a brake cylinder device, which is insertable into the recess of the system housing and has at least one brake cylinder and a predetermined cylinder length is provided; and a return spring, which has a predetermined spring length and a predetermined cross-sectional shape and is insertable into the recess of the system housing, is provided.

The modular system of the present invention can also be characterized by the features mentioned in connection with the method of the present invention and by the advantages of the method, and vice versa.

Further features and advantages of embodiments of the present invention arise from the following description with reference to the figures.

### BRIEF DESCRIPTION OF THE DRAWINGS

The present invention is explained in greater detail below with reference to the embodiment examples shown in the schematic figures.

FIG. 1A shows a schematic illustration of a brake force device from a modular system according to an embodiment example of the present invention.

FIG. 1B shows a schematic illustration of a pressure generator from a modular system according to an embodiment example of the present invention.

FIG. 2 shows an illustration of a wire cross-section for a return spring from a modular system according to an embodiment example of the present invention.

FIG. 3 shows a block diagram of method steps of the method for producing a brake force device according to an embodiment example of the present invention.

Identical reference signs in the figures denote identical or functionally identical elements.

### DETAILED DESCRIPTION OF EXAMPLE EMBODIMENTS

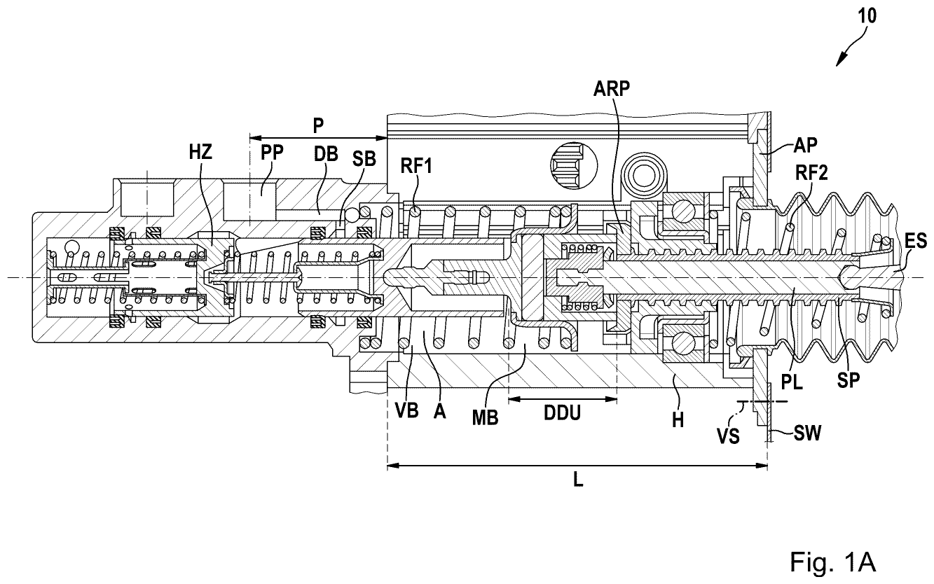

FIG. 1A shows a schematic illustration of a brake force device from a modular system according to an embodiment example of the present invention.

FIG. 1A shows a longitudinal section of a brake force device, which has a recess A, which has a front region VB and a center region MB, in the interior of the system housing H. The system housing H has a predetermined system length L and an elongate inner recess A, wherein the system housing H is usable for a power brake or for an auxiliary brake but also for a pressure brake unit, as shown in FIG. 1B. A brake cylinder device HZ, such as a tandem master brake cylinder, may be inserted in the recess A of the system housing H. Furthermore, there may be a return spring RF, which has a predetermined spring length and a predetermined wire cross-sectional shape and is insertable into the recess A of the system housing H. The brake cylinder device HZ is arranged in the front region VB, and the return spring RF extends into the center region MB. The brake cylinder device HZ may comprise a primary port PP, and a through-hole DB may extend in horizontal alignment between the sniff hole SB and the primary port (connection to the reservoir) PP.

Furthermore, a first distance P between the primary port PP and the system housing H may have a predetermined value. As a result of this distance (minimum distance), which may be the same for different types of the brake force device, the brake cylinder device HZ for an auxiliary brake (FIG. 1A) or for a pressure generator (FIG. 1B) can have the same physical dimensions and inner structure. In the center region, the auxiliary brake comprises a driver demand unit DDU, which is not required for a pressure brake unit (FIG. 1B). In the center region MB or at least on the spindle SP, an anti-rotation plate ARP can be formed as a flat plate.

The return spring RF may comprise a first return spring RF1 between the brake cylinder device HZ and the DDU as well as a second return spring RF2, the latter acting between the spindle SP and the system housing H or acting only on the transmission GE and not on the input rod ES.

The sum of the forces of the two return springs RF1 and RF2 is comparable to the force of the one return spring of FIG. 1B.

The input rod ES may be connected to a plunger PL.

An adapter plate AP for fastening the brake force device 10, for example by means of a screw connection VS, to a vehicle bulkhead SW in the engine compartment may be present on a lateral side of the system housing H.

FIG. 1B shows a schematic illustration of a pressure brake unit from a modular system according to an embodiment example of the present invention.

FIG. 1B shows the same system housing H as can be seen in FIG. 1A, also with the same dimensions of the length L and the recess A. The first distance P and the dimensions of at least some components may also be the same, which encourages the application of the modular system for the brake force device 10. Due to the driver demand unit DDU being omitted in FIG. 1B, the anti-rotation plate ARP may be cup-shaped or canister-shaped.

When the driver demand unit DDU is omitted, the freed installation space may be used to reduce the length of the overall structure.

The TMC can be pushed into the center region MB toward the ARP. Furthermore, the spindle nut SPM with the spindle SP can be pushed to the left into the center region MB toward the TMC, wherein the installation length can also be reduced by the length of the driver demand unit DDU.

In the case of a greater distance Z (due to the DDU being omitted), the diameter of the (a) return spring RF can advantageously be reduced while retaining the inexpensive round wire.

A worm wheel and the spindle nut SPM can rotate. A gap SPT may be present between the cup-shaped anti-rotation plate ARP and the rotating spindle nut SPM. The anti-rotation plate ARP can be supported with finger elements FE on a groove NN in the system housing H.

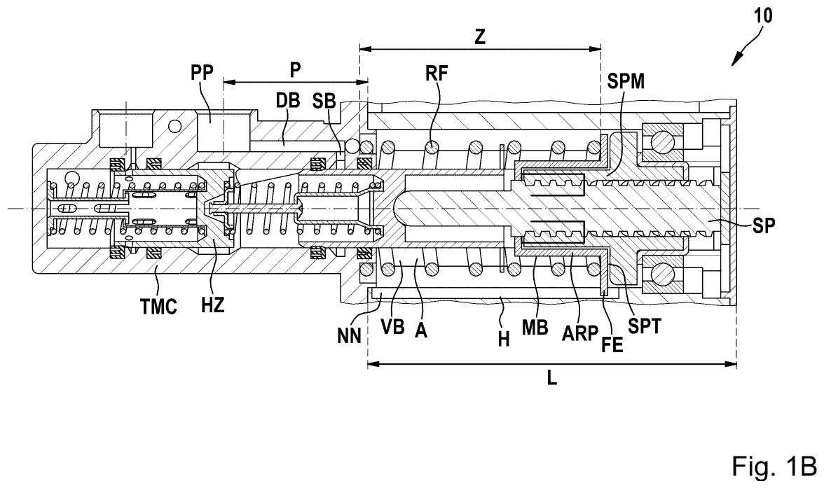

FIG. 2 shows an illustration of a wire cross-section for a return spring from a modular system according to an embodiment example of the present invention.

The illustration of FIG. 2 may relate to the case of FIG. 1A with the brake force device and one of the two return springs or to the case of FIG. 1B with the one return spring. Accordingly, the partial illustrations a, b and c show different wire cross-sections of the return spring RF with an increasing ellipticity/rectangularity of the wire radius R from a to c. The lower region shows the associated block lengths BL, which decrease due to the elliptical/rectangular cross-section. With the same characteristic, the shorter block length allows for a shorter spring.

The return spring RF may have a circular or elliptical cross-section, perpendicular to a central axis of the return spring RF, with a predetermined radius or a predetermined semimajor or semiminor axis, and wherein the return spring RF has a predetermined length along the central axis.

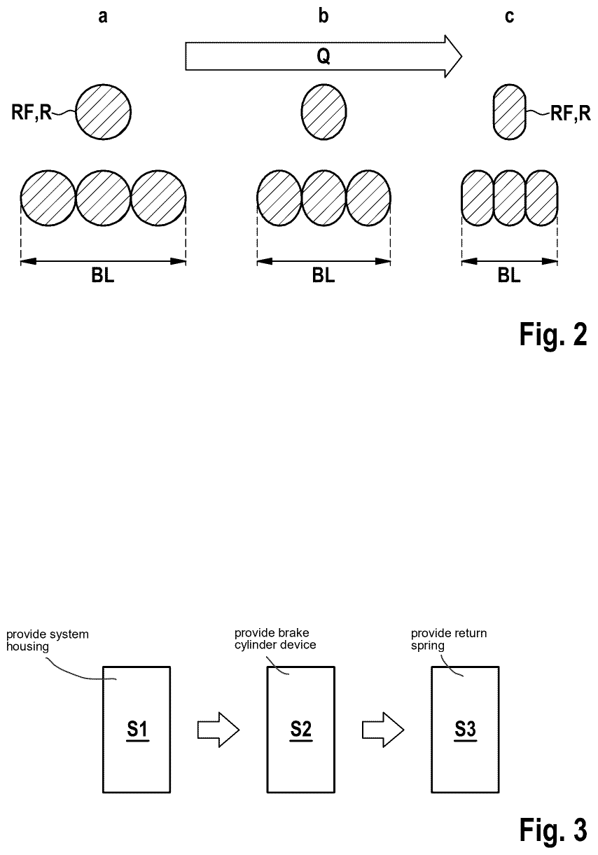

FIG. 3 shows a block diagram of method steps of the method for producing a brake force device according to an embodiment example of the present invention.

In the method for producing a brake force device from a modular system, a system housing with a predetermined system length and an elongate inner recess is provided S1, wherein the system housing is usable for an auxiliary brake and/or for a power brake and/or for a pressure generator; a brake cylinder device, which is insertable into the recess of the system housing and has at least one brake cylinder and a predetermined cylinder length is provided S2; and a return spring, which has a predetermined spring length and a predetermined cross-sectional shape and is insertable into the recess of the system housing, is provided S3.

Although the present invention has been completely described above with reference to the preferred embodiment example, it is not limited thereto but can be modified in many ways.

1-14. (canceled)

15. A modular system for a brake force device, comprising:
a system housing with a predetermined system length and an elongate inner recess, wherein the system housing is usable for an auxiliary brake and/or for a power brake and/or for a pressure generator;
a brake cylinder device, which is insertable into the recess of the system housing and has at least one brake cylinder and a predetermined cylinder length; and
a return spring, which has a predetermined spring length and a predetermined cross-sectional shape and is insertable into the recess of the system housing.

16. The modular system according to claim 15, wherein the recess of the system housing includes a front region and a center region, wherein the brake cylinder device is insertable into the front region.

17. The modular system according to claim 16, wherein the brake cylinder device includes a primary port and a sniff hole, and a through-hole extends in horizontal alignment between the primary port and the sniff hole and at least in regions along the elongate recess.

18. The modular system according to claim 17, wherein a first distance between the primary port and the system housing has a predetermined value.

19. The modular system according to claim 15, wherein the return spring has a circular or elliptical wire cross-section, perpendicular to a central axis of the return spring, with a predetermined radius or a predetermined semimajor or semiminor axis, and wherein the return spring has a predetermined length along the central axis.

20. The modular system according to claim 19, wherein the return spring has a non-circular wire cross-section.

21. The modular system according to claim 15, wherein the brake cylinder device for an auxiliary brake and/or for a power brake and/or for a pressure generator has the same physical dimensions and inner structure.

22. The modular system according to claim 15, wherein the auxiliary brake and/or the power brake and/or the pressure generator are provided from a modular kit with an identical transmission including a worm transmission, at an identical position and include a structurally identical brake cylinder device and/or a structurally identical system housing and/or a structurally identical spindle with a spindle nut.

23. The modular system according to claim 22, wherein the auxiliary brake includes a driver demand unit, which is arranged between the brake cylinder device and a spindle nut, wherein the spindle is hollow-bored and a plunger, which is mounted therein and connected to the driver, actuates the driver demand unit.

24. The modular system according to claim 22, wherein, when used for the auxiliary brake and/or the pressure generator, an anti-rotation torque of the spindle transmission is supported on at least two grooves of the system housing via at least two finger elements of an anti-rotation plate, which is connected to the spindle, wherein the grooves are rectangular grooves.

25. The modular system according to claim 22, wherein, when used for the pressure generator, the the anti-rotation torque is transmitted around the spindle nut using a canister or two offset levers before being supported via two finger elements.

26. The modular system according to claim 22, wherein, a lateral side of the system housing includes an adapter plate for fastening the brake force device to a vehicle bulkhead in an engine compartment of a vehicle.

27. The modular system according to 22, wherein the pressure generator includes a cover for sealing the system housing.

28. A method for producing a brake force device from a modular system, the method comprising the following steps:
providing a system housing with a predetermined system length and an elongate inner recess, wherein the system housing is usable for an auxiliary brake and/or for a power brake and/or for a pressure generator;
providing a brake cylinder device, which is insertable into the recess of the system housing and has at least one brake cylinder and a predetermined cylinder length; and
providing a return spring, which has a predetermined spring length and a predetermined cross-sectional shape and is insertable into the recess of the system housing.
